(19) United States
(12) Patent Application Publication
(10) Pub. No.: US 2010/0146388 A1
(43) Pub. Date: Jun. 10, 2010

(54) METHOD FOR DEFINING CONTENT DOWNLOAD PARAMETERS WITH SIMPLE GESTURE

(75) Inventors: Kaj Markus Makela, Helsinki (FI); Saija-Maaria Lemmela, Helsinki (FI)

Correspondence Address: DITTHAVONG MORI & STEINER, P.C., 918 Prince Street, Alexandria, VA, 22314, US

(73) Assignee: Nokia Corporation

(21) Appl. No.: 12/329,493

(22) Filed: Dec. 5, 2008

(51) Int. Cl. G06F 3/041; G06F 15/16; G06F 3/048

(52) U.S. Cl. 715/702; 709/219; 715/748

(57) ABSTRACT

A system and method of defining download parameters for downloading a desired content item is provided. A user presented with content on a display for downloading selects a desired content item to be downloaded by pointing to a visual thumbnail icon or representation of the desired content item. A download parameter interface is presented (e.g., overlaid on the icon) on the display. The user is then able to adjust one or more download parameters associated with the desired content item. Upon achieving the desired values for the one or more download parameters, the desired content item is processed in accordance with the desired values, and is then presented to the user.

### FIELD

Various embodiments relate to the accessing and/or downloading of media content. More particularly, various embodiments relate to specifying media content download parameters with a simple gesture.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Over the past few years, mobile device capabilities have been increasing at a rapid pace, resulting in devices which provide, for example, increased processing power, larger screen displays, and improved digital services. As a result, consumer demand for media/multimedia content and applications, such as on-demand services that can be delivered anywhere and anytime, has also increased. However, the specific capabilities of these mobile devices can vary. Even non-mobile devices, such as desktop computers and gaming consoles can have differing capabilities, stemming from the hardware/software with which such devices are implemented, as well as the applications being executed thereon.

Mobile device users generally access media content, such as text, audio, video, or some combination thereof, that can be located on networked servers or in their private, distributed storages on a network. Because such content is accessed through some type of network connection, varying delays may occur when receiving the content. These delays can occur for various reasons including, but not limited to, e.g., the network connection itself, device performance, network traffic, server status and/or the amount of data representing the content that is to be transferred.

Download parameters can also affect a user's experience, where the download parameters can vary with regard to various attributes, such as speed/duration, size/resolution and quality. That is, the less data regarding certain content that is sent, the faster the download speed of that content. At the same time, however, when less data regarding the content is sent, the quality and size/resolution of the content also decreases.

Depending on the network connection used for downloading content, the price for utilizing the network connection to download the content can also vary as a function of the amount of data downloaded and the connection rates (e.g., either based on connection time, the speed of downloading available for that particular connection, or the amount of data). For example, if more than one network connection is available for the purposes of downloading, their prices and speed may differ.

In light of the above, a user can set quality requirements for the content to be downloaded based on how the content is to be used. The level of quality requirements varies based on the content type and what kind of information or experience the user is seeking from it. Some content may be of the type that requires it to be received quickly, without as much focus on the quality of the content. News, stock quotes, weather updates, etc. are some examples of this type of content, where the quality must simply be sufficient to present readable text/images as long as continuity of receipt of the content is maintained. Other types of content may require that it have very good or even perfect quality. Examples of this type of content can include, e.g., artistic images, film, or music videos, which may require very good image quality and sound, because such content is enjoyed for aesthetic reasons. Hence, waiting (some amount of time) for the content to download may not pose a problem for a user, but still, lessens or “spoils” the experience.

In order to allow a user to define, e.g., the quality, accuracy, desired download duration, needed for content, prior art systems and methods utilize complex technical configuration dialogs or require extra effort on the part of the user. For example, certain prior art relies on the use of different versions of content (e.g., video) that may be provided to a user through separate links on a web page, where the different versions are associated with different sizes of the video content. Alternatively, client end-parameters can also be utilized for content version selection, such as by providing a particular web page version of content for different web browsers.

### SUMMARY OF VARIOUS EMBODIMENTS

One exemplary embodiment relates to a method of defining visual content download parameters. The method includes presenting values of download parameters of a digital media content item relative to a touch point, and adjusting the values of the download parameters, if needed, by moving a touch point relative to a representation of the digital media content item. The method further includes transferring of the digital media content item based on one of the presented and the adjusted values by releasing the touch point. Another exemplary embodiment relates to an apparatus for defining visual content download parameters comprising a processor. The processor is configured to present values of download parameters of a digital media content item relative to a touch point, and adjust the values of the download parameters, if needed, by moving a touch point relative to a representation of the digital media content item. The processor is further configured to transfer the digital media content item based on one of the presented and the adjusted values by releasing the touch point.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of various embodiments are described by referring to the attached drawings, in which:

FIG. 1 is a flow chart illustrating exemplary processes performed during a download parameter interface method in accordance with various embodiments;

FIG. 2 illustrates exemplary methods of positioning a download parameter interface in relation to a contact point in accordance with various embodiments;

FIG. 3 illustrates an exemplary two-dimensional download parameter interface with time-quality dimensions in accordance with various embodiments;

FIG. 4 illustrates an exemplary download parameter interface with size and quality parameters presented in relation to time in accordance with various embodiments;

FIG. 5 is a graphical representation of an exemplary download parameter interface in accordance with various embodiments, illustrating image area division relative to corresponding download parameters;

FIG. 6 is a graphical representation of an exemplary download parameter interface in accordance with various embodiments illustrating “hot” areas with respect to corresponding download parameters;

FIG. 7 is an overview diagram of a system within which various embodiments may be implemented;

FIG. 8 is a perspective view of an electronic device that can be used in conjunction with the implementation of various embodiments; and

FIG. 9 is a schematic representation of the circuitry which may be included in the electronic device of FIG. 8.

### DETAILED DESCRIPTION OF VARIOUS EMBODIMENTS

Various embodiments provide a download parameter interface/download parameter interface method for specifying media (e.g., video) content download parameters with a simple gesture, such as a single stroke (i.e., drag-drop) gesture or a single “click.” A user presented with content on a display (e.g., in a content browsing view of a browser) for downloading selects a desired content item to be downloaded by pointing to a visual thumbnail icon/representation of the desired content item. The user, using a graphical pointer, (e.g., a cursor controlled by a mouse) points to/selects the icon, at which time, the download parameter interface is presented (e.g., overlaid on the icon) on the display. The user is then able to adjust one or more download parameters associated with the desired content item. It should be noted that if the display is, e.g., a touch screen display, the user may control the cursor by using his/her finger, a stylus, or similar tool. Alternatively, a cursor need not be displayed to the user, where instead, the icon of the desired content item or various portions of the download parameter interface is highlighted or otherwise indicated as selected upon being “touched” by the user's finger, stylus, etc.

Depending upon where (relative to the icon or to the download parameter interface space) the user first presses/selects the icon, an initial “press-down-point” is established. By changing the position of the pointer from the press-down-point, one or more download parameter values are adjusted. As described above, various embodiments need not rely on a graphical pointer to visually indicate the adjustment of the download parameter values. That is and for example, dynamic shading, highlighting, darkening/lightening, color changing, etc. can be displayed to the user to indicate a change in one or more of the download parameter values. Once the user is satisfied with his/her adjustments, the user “releases” the press to set the adjustment value(s). The download parameters (as adjusted or at their default) are then sent to a media server that hosts the desired content item. The media server in turn transmits the desired content to a client, e.g., an application resident on the user's device, the device itself, etc. The desired content is sent in the requested format/according to the set parameters, either as a file or content stream. It should be noted that different methods and systems for displaying the download parameter interface to a user, as well as different methods of indicating selection and/or adjustment to the user are contemplated in accordance with various embodiments, and the methods and systems described herein are merely exemplary.

The download parameter interface is displayed to the user continuously during the adjustment of the download parameter values. Additionally, the relation between different parameters (if different parameters can be adjusted) are continuously displayed to the user. That is, the download parameter interface relays to the user, e.g., how a change in one parameter value affects the value of another download parameter. For example, if image quality is a download parameter that can be adjusted with the download parameter interface and when the quality is increased by the user, the download parameter interface graphically indicates/informs the user that the duration of the download also increases. Likewise, if the user indicates a desire to reduce the quality of the desired content item, the download parameter interface substantially simultaneously indicates that the download duration is decreased as well.

With regard to the implementation of the download parameter interface/download parameter interface method in accordance with various embodiments, certain “actors” are referred to as follows. As described above, a user terminal device is a device, e.g., mobile telephone with a touch screen display, laptop computer, etc. that the user utilizes to view one or more desired content items. The user terminal device preferably has network capabilities, a visual display (e.g., the touch screen) and a pointing device or other mechanism for receiving, e.g., touch commands. A client application can refer to an application running on/implemented within the user terminal device. The client application preferably includes a visual or pointing/touch-based user interface, and is able to display remotely stored media objects (e.g., content) as icons, thumbnails, or via some other graphical representation method, on the display of the user. Network infrastructure refers to one or more carriers for data and communication between the user terminal device and the media server. It should be noted that various embodiments are carrier-agnostic. That is, various embodiments can be implemented regardless of the type of network infrastructure that the user terminal device and/or media server operate on, e.g., a cellular network, a wi-fi network, wired Ethernet network, etc.

As already described above and in accordance with one embodiment, a media server refers to a server/one or more media applications running on a server, that is capable of receiving media content requests along with download parameters values from one or more user terminal devices. The media server, based on, e.g., the download parameter values received with the media content, selects the appropriate data content from a database and/or modifies the data content based on the download parameter values and transfers the data content to the user terminal device. In accordance with another embodiment, a content server refers to a server/one or more applications running on the content server that receives content requests and transfers the content to the requester (e.g., the media server). It should be noted that the content server can be co-located with the media server in accordance with certain embodiments.

As noted above, various embodiments allow a user to adjust download parameters via a user terminal device with a graphical user interface that displays/visually represents content items stored on remote networked storage as thumbnail icons. The user manipulates the icons with a pointer device that can be implemented as, e.g., a two-dimensional/surface-based input, such as a stylus or finger on a touch screen or other touch sensitive surface (e.g., a sketch board). Other embodiments are implemented in conjunction with a display that can be controlled via, e.g., a mouse, a trackball, a joystick, a cursor, rocker keys, or any other pointing device/mechanism. Additionally, control can be effectuated via a three-dimensional motion detecting device, a Wii-mote, a Nokia motion band, etc.

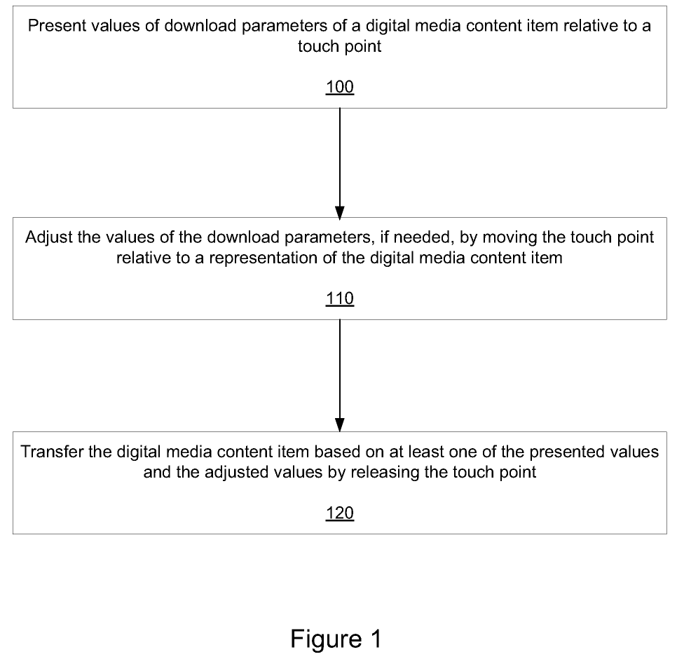

FIG. 1 illustrates various processes performed for adjusting download parameters associated with a desired content item in accordance with various embodiments. It should be noted that the such processes are exemplary and that more or less processes may be performed. Furthermore, the processes described herein may be performed in differing order in accordance with various embodiments. At 100, presenting values of download parameters of a digital media content item relative to a touch point is performed. At 110, adjusting the values of the download parameters is performed, if needed, by moving a touch point relative to a representation of the digital media content item. At 120, transferring of the digital media content item based on one of the presented and the adjusted values by releasing the touch point is performed. That is, upon a user pointing to/selecting an icon or other graphical representation of a desired content item to be downloaded, a download parameter interface is opened, wherein the download parameter interface is representative of at least one download parameter. As described above, the user can be utilizing, e.g., a mobile device with a touch screen display, where the pointing to/selecting of the icon can be performed by the user touching a stylus or his/her finger to the touch screen display. The download parameter interface can comprise a spatial, visual object in which each position represents a combination of download parameters. Additionally, the download parameter interface is positioned on the display in relation to the point of touch.

In accordance with one embodiment, positioning of the download parameter interface is based upon a “pivot in contact point” method. When the download parameter interface is triggered, a press-down-point is established. The download parameter interface is opened (e.g., overlaid) on/about the icon of the desired content item, where the “space”/“area” comprising the download parameter interface is, e.g., centered around the press-down-point. A pointer or other visual indication is set to a center/middle point in the download parameter interface. Such a center/middle position can be configured to represent medium values of each download parameter of the combination of download parameters. For example, the center/middle position can be indicative of a desired content item that is medium sized, of medium quality, and have a medium download duration. The location or position of the download parameter interface relative to the icon of the desired content item is dynamic because as described above, the download parameter interface is opened and positioned relative to the press-down-point. Additionally, a “quick click” can be configured for the download parameter interface so that a “quick click” by the user will select middle value of all the download parameters.

In accordance with another embodiment, positioning of the download parameter interface is based upon a “pivot in predefined point” method, where the middle point of the download parameter interface space has a predefined, known relation to the center/middle of the icon representing the desired content item. For example, the middle point of the download parameter interface space can be configured to correspond with the center/middle point of the icon representing the desired content item. Hence, the positioning of the download parameter interface is “static” in relation to the icon. Thus, when the download parameter interface is opened, the press-down-point established by the user corresponds to an adjustment value(s) and a pointer or some other visual indicator is positioned relative to the corresponding center/middle of the icon. This enables expert users to use “quick click” to select the download parameter value(s) he/she wants substantially instantaneously. For example, the user may trigger the opening of the download parameter interface by “touching” the desired content item icon and at the same time, automatically indicate by the position of the touch, the desired download parameter value(s).

In accordance with yet another embodiment, positioning of the download parameter interface is based upon a “default value in contact point” method, where the pointer or visual indication displayed upon opening the download parameter interface is automatically set to a position which is most likely to be the target parameter value(s)/set. This minimizes any need to move the pointer or adjust the download parameter value(s). This “default” point may be determined based on, e.g., previously/commonly used, related settings, context/content type-related point, etc. Again, the location of the download parameter interface is dynamic in accordance with this particular embodiment.

The values associated with each download parameter of the combination of download parameters corresponding to the touch point are presented to the user. The parameter values corresponding to the pointer/visual indication position on the download parameter interface are presented in a clear manner to provide the user with an understanding of how value changes in relation to the movement of the pointer/visual indication. This can be accomplished, e.g., with visual methods as described above, and including but not limited to changes in the thumbnail image/icon representative of the desired content item, color scales, symbols, changes of visual motives, transparency, contrast, size, alphanumeric symbols, etc.

If needed, the values of the combination of download parameters are adjusted based upon the user moving the pointer, his/her finger or stylus to a desired or suitable position on or within the download parameter interface space. The visual cues, symbols, and/or indications are updated accordingly. A Upon the release of the touch point, the presented values or adjusted values are set, and a request is sent for the desired content item along with values of the combination of download parameters (e.g., the adjusted values or a default/initial “quick click” value as described above). It should be noted that “releasing” the touch point can refer to the user lifting his/her finger or stylus, releasing a button, shaking or tapping the user terminal device, etc. The request is sent to the media server, where the values are further adapted/calculated and/or processed according to the characteristics of the receiving user terminal device (e.g. maximum image size, color depth, frame-rate that can be displayed, bitrate for receiving, sample bit amount for audio, etc.) Feedback information and/or signals can be displayed to the user indicating that the request is being processed and/or the user terminal device is awaiting a response to the request.

In accordance with one embodiment, when the media/content server receives the request, the desired content item is fetched and processed in accordance with the requested download parameter values. For example, the desired content item may be compressed to a smaller size and/or frame rate from its original format. Alternatively and in accordance with another embodiment, the media/content server may have different “ready made” versions of content to be selected from. For example, the media/content server may have access to small, medium, and large versions of each content item so as to avoid heavy runtime processing that may be involved in converting content items in accordance with requested download parameter values.

If the operation was successful, the media/content server can send a response to the client/user terminal device and the client/user terminal device receives the desired content item in accordance with the requested download parameter values. It should be noted that once the client receives the response, a download indicator can be displayed, which is updated accordingly during the download. If the desired content item is to be streamed, an appropriate content viewer is opened and streaming download indicators are displayed which again, are updated accordingly during the streaming download.

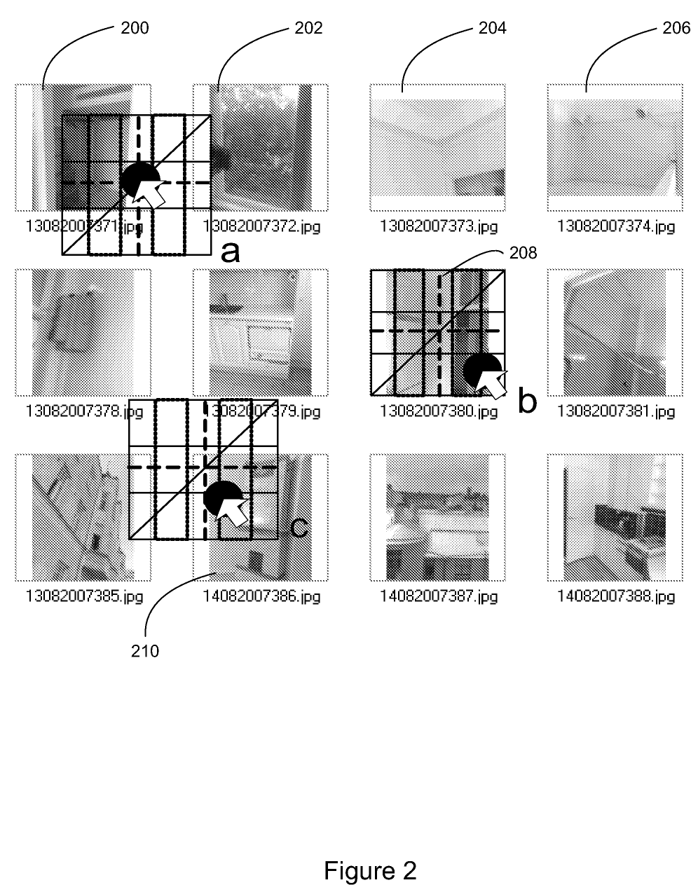

FIG. 2 illustrates exemplary methods of positioning a download parameter interface in relation to a contact point in accordance with various embodiments. As described above and in accordance with one embodiment, a pivot in contact point method is utilized to position the download parameter interface upon being triggered/opened. FIG. 2 shows a plurality of potential desired content items having a Joint Photographic Experts Group (JPEG) format, where the desired content items are visually represented by thumbnail icons (e.g., icons 200, 202, 204, 206, etc.) An instance “a” of the download parameter interface in accordance with one embodiment is shown, where the press-down-point (indicated by the circle and arrow graphic) is established at the center/middle of the download parameter interface area, and the download parameter interface is dynamically overlaid on icon 200. In accordance with another embodiment and as described above, positioning of the download parameter interface upon being triggered or opened is static when positioning is based upon the pivot in predefined point method. An example of this method is shown with instance “b” of the download parameter interface, where the download parameter interface is overlaid on icon 208, where the center/middle of the download parameter interface corresponds with the center/middle of the icon 208. The initial press-down-point (indicated by the circle and arrow graphic) establishes the adjusted values desired by the user. In accordance with still another embodiment and as described above, positioning of the download parameter interface relative to icon 210 is based upon the default value in contact point method. That is, instance “c” of the download parameter interface is dynamically positioned relative to the icon 210, and the triggering of the download parameter interface opens with the circle and arrow graphic at a default position on the download parameter interface area.

The download parameter interface space can be presented as a two dimensional (e.g. square, circle) visual object. Alternatively, the download parameter interface space can also be presented as a three dimensional visual object in the form of a cube or ball, for example. Each dimension can be representative of a content download parameter. It should be noted that the number of dimensions can be varied, as well as the download parameters that are configured for each dimension. The visual object is limited by the maximum and minimum values of each axis, e.g., best and worst available quality, fastest and slowest download time, smallest and largest image size, most expensive and cheapest connection, etc.

As a result, a user can adjust the two/three download parameters by moving, e.g., a pointer in relation to the axis representing the download parameter he/she wants to adjust. For example, a user may want to decrease the price of a download, the duration of the download, and/or increase the quality, size or amount of colors (i.e., bigger-better-faster-cheaper). A change in one of the dimensions will affect other parameters, e.g., better quality or bigger picture relates to a longer download time. Hence, the position in the download parameter interface space changes based on the user's interaction. Additionally, not only is the user shown his/her current position on the download parameter interface, but also, e.g., the quality classification, estimated download time, and estimated price of the download, may be shown as text/numbers. When the user has found a suitable combination of parameters, he/she releases the pointer (finger, stylus, etc.) as described above.

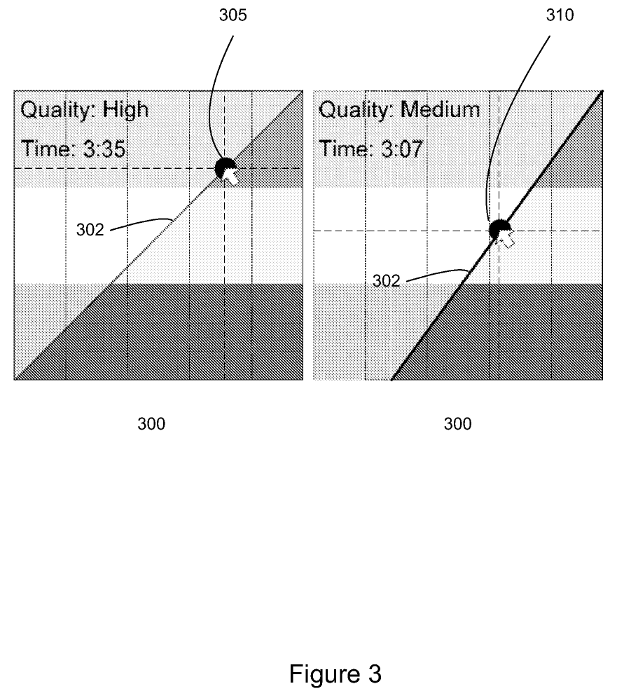

FIG. 3 illustrates an exemplary two-dimensional download parameter interface visual object 300 in accordance with various embodiments. The horizontal axis of the visual object 300 can be configured to relate to download time and the vertical axis can be configured to be indicative of quality. The relationship between time and quality can be a linear relationship indicated by the diagonal line 302 (e.g., quality and download duration decrease and increase at the same rate). It should be noted that the relationship between two download parameters need not be linear. In a first scenario, the download parameter interface visual object 300 is shown with a pointer 305. The position of the pointer 305 is indicative of a high quality content item that can be downloaded in 3 minutes, 35 seconds. In a second scenario, the position of the pointer 310 indicates that the user has chosen a medium quality content item that can be downloaded in 3 minutes, 7 seconds.

Three or more dimensional visualization of download parameters can be used when there are multiple issues affecting a user's decision in downloading a desired content item. Exemplary issues include, e.g., price, which may be a factor in scenarios where several network connections are available, each with a different download speed and price. If, for example, multiple connections are not available or the fastest connection is the cheapest, the two dimensional visual object may be more suitable, although various embodiments can be configured in many different ways to suit, e.g., network carriers, content providers, etc.

In accordance with other embodiments, the thumbnail icon or other visual representation of the desired content item itself can be used to present visual indications of download parameter adjustment. As described above and illustrated in, e.g., FIG. 2, the download parameter interface can be overlaid on a thumbnail icon. Instead of implementing, e.g., color changes, highlighting, etc. to be shown on/with the download parameter interface, the scale of the thumbnail icon itself can be changed, the color depth of the icon itself can be altered, as well as the pixel size, etc. The icon may be animated with a series of images showing levels of frame-rates in accordance with another embodiment.

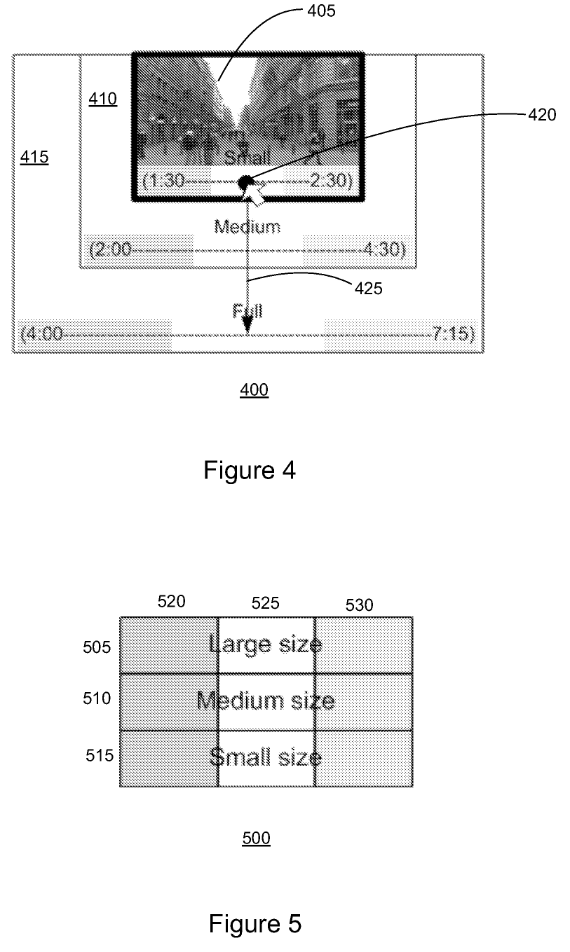

FIG. 4 illustrates exemplary download parameter interface 400 with size and quality parameters presented in relation to time in accordance with various embodiments. Download parameter interface 400 is configured so that the size of a desired content item can be adjusted along the vertical axis and quality can be adjusted along the horizontal axis. Area 405 shows an icon or graphical object representative of the desired content item that corresponds with a small sized content item and a certain range of quality. Additionally, the download time range between, e.g., 1 minute, 30 seconds and 2 minutes, 30 seconds corresponds to the range of possible/differing qualities of the small sized content item. Area 410 is representative of a medium sized content item with its own range of qualities and corresponding download times. Area 415 represents a full sized content item and range of qualities and commensurate download times. The pointer 420 can be moved or dragged throughout the download parameter interface to adjust the above-described parameters/values. It should be noted that although the pointer 420 is shown as having the ability to be moved vertically in the direction of arrow 425, pointer 420 is capable of being moved horizontally to adjust quality/time as well. As described above, the pointer 420 can also be diagonally or in any other appropriate direction to arrive at a desired combination of parameter values.

With regards to the receiving context of various embodiments and in accordance with one embodiment, it should be noted that characteristics of the user terminal device characteristics are taken into account. That is, the user terminal device may have certain characteristics that limits the range of permissible values for certain download parameters. For example, a user terminal device may have limits with regard to a maximum size of video content that can be displayed thereon. Therefore, the download parameter interface scales download parameter values to this maximum size allowed by the user terminal device when rendering the download parameter interface and sending the download parameter values to the media/content server, whereupon the client/user terminal device can receive the desired content item from the media/content server.

As to the download parameter interface itself and as described above, the download parameter interface can be presented as an overlay to an icon or other representation of a desired content item. To accomplish this overlay aspect of various embodiments, the download parameter interface can be drawn as a semi-transparent rectangle or square. When the download parameter interface is triggered and opened, it is positioned either dynamically or statically as noted above. Once that position is determined, however, the position becomes fixed in relation to the icon or content item representation. FIG. 5 illustrates an exemplary download parameter interface 500, where an, e.g., image area, is divided into corresponding download parameters and values. There are three horizontal rows (505, 510, and 515) each of which represents a size of a desired content item, e.g., large, medium, and small, respectively. There are three vertical columns (520, 525, and 530) each of which represents a quality of coding applied to the desired content item, e.g., low quality, medium quality, and high quality. Thus, a nine-cell matrix is created in which each cell has own size-quality parameter combination that can trigger the download of different sized/different quality content that incurs different download times with a current network connection type.

It should be noted that a user may point to/touch any part of the desired content item icon to activate the download parameter interface. If the icon is too small to be divided into several finger-“pointable”/“touchable” areas, the icon and/or download parameter interface can be zoomed in on to enable more accurate spatial pointing/touching/selecting. Additionally and as the download parameter interface opens, the user's finger will be positioned on some parameter value combination. If the size of icons and the download parameter interface is maintained for subsequent desired content items, the user can immediately select a parameter value combination by touching the icon at a location that would correspond to the desired parameter value combination. Moreover, if a user's finger or stylus is pressed on a location/parameter value combination that the user does not desire, the user keeps his/her finger or stylus pressed to the display of the user terminal device and moves the finger of stylus to the desired icon area/download parameter interface space. Again and as described above, the download time and file size indications are updated accordingly.

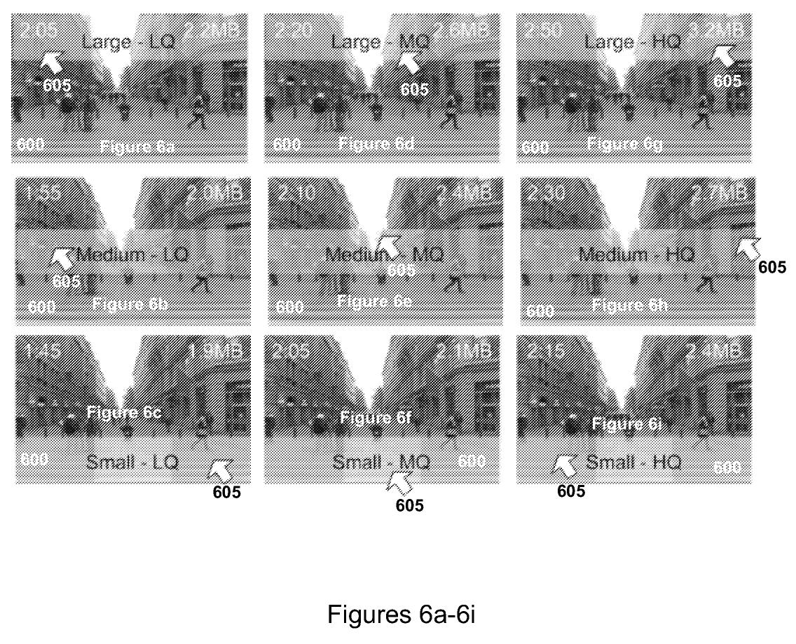

FIGS. 6a-6i illustrates an exemplary instances of a download parameter interface 600 in accordance with various embodiments, where an underlying icon area is divided into “hot” areas with corresponding download parameters and values. FIGS. 6a-6c illustrate the download parameter interface 600 overlaid on an icon of a desired content item, where the arrow shown in each of FIGS. 6a-6c is indicative of a hot area. The arrow 605 in FIG. 6a is pointing to a hot area indicative of a low quality (LQ), large size content item. The arrow 605 in FIG. 6b points to a hot area indicative of a LQ, medium size content item. The arrow 605 in FIG. 6c points to a hot area indicative of a LQ, small size content item. The arrow 605 in FIGS. 6d, 6e, and 6f points to hot areas indicative of a medium quality (MQ) content item of large, medium, and small size, respectively. Likewise, the arrow 605 in FIGS. 6g, 6h, and 6i points to hot areas indicative of a high quality (HQ) content item of large, medium, and small size, respectively. Additionally, the download parameter interface can display the appropriate download times and/or file sizes associated with each size/quality download parameter combination. It should be noted that the above-described “hot” areas may, but are not required to follow, e.g., one of the matrices described above.

Various embodiments described herein provide an improved user experience when downloading a desired content item. For example, a “one-press” implementation of a download parameter interface can be configured so that a user only needs to make a single press/motion to download media content suited to the user's desired usage purpose, user terminal device characteristics, and/or user preference. Visual indications and/or cues are provided to a user throughout the use of the download parameter interface, and less time is required to initiate a download procedure. Various embodiments are also capable of supporting both novice users and expert users. Furthermore, multiple links for different versions of a particular piece of content/file are no longer necessary. Seamless integration is provided by the overlay aspect of various embodiments as well, and a user has the ability to select the type of experience he/she desires with respect to downloading content. Moreover, dynamic download time can be determined and presented to a user based on user requirements and use context.

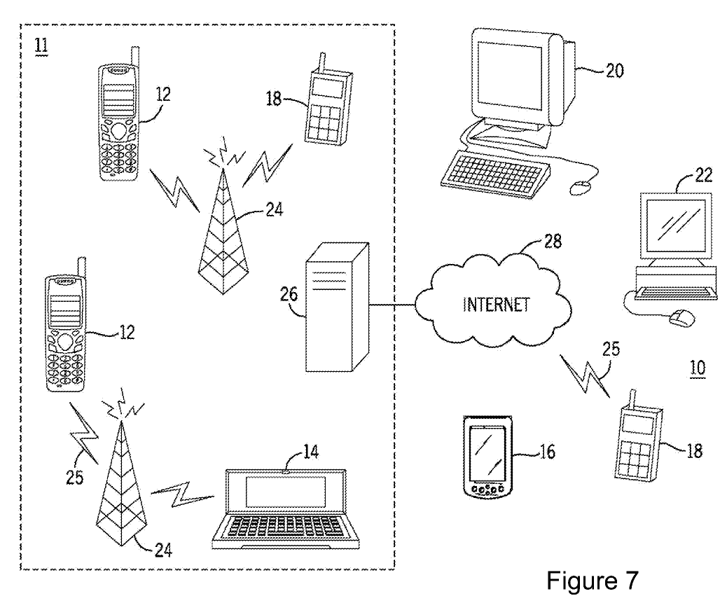

FIG. 7 shows a system 10 in which various embodiments can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 7 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments may communicate using various media including, but not limited to, radio, infrared, laser, cable connection, and the like.

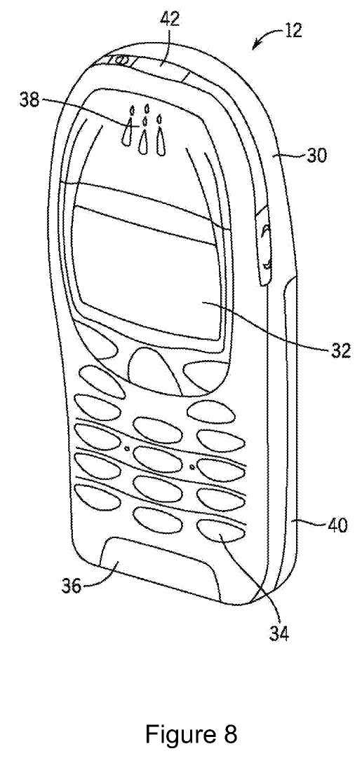

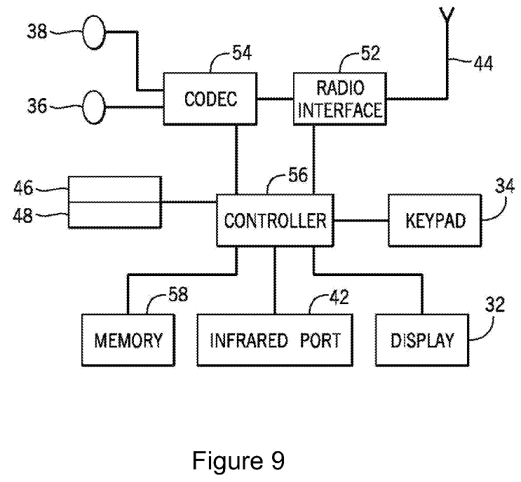

FIGS. 8 and 9 show one representative electronic device 12 within which various embodiments may be implemented. It should be understood, however, that various embodiments are not intended to be limited to one particular type of device. The electronic device 12 of FIGS. 8 and 9 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The display 32 can comprise a touch screen through which various actions/processes/operations are effectuated via gestures or controls made by a finger, stylus, or other similar instrument. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Various embodiments may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments has been presented for purposes of illustration and description. The foregoing description is not intended to be exhaustive or to limit various embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize various embodiments and with various modifications as are suited to the particular use contemplated. The features of the embodiments described herein may be combined in all possible combinations of methods, apparatus, modules, systems, and computer program products.

What is claimed is:

1. A method, comprising:
presenting values of download parameters of a digital media content item relative to a touch point;
adjusting the values of the download parameters, if needed, by moving the touch point relative to a representation of the digital media content item; and
transferring the digital media content item based on one of the presented and the adjusted values by releasing the touch point.

2. The method of claim 1 further comprising, positioning an interface representative of a combination of the download parameters relative to the touch point, wherein the positioning of the interface comprises locating the interface dynamically with respect to the representation and the touch point is set to be indicative of medium values of the combination of download parameters.

3. The method of claim 1 further comprising, positioning an interface representative of a combination of the download parameters relative to the touch point, wherein the positioning of the interface comprises locating the interface statically with respect to the representation and the touch point is automatically set to be indicative of one of medium values of the combination of download parameters and adjusted values of the combination of download parameters without requiring the movement of the touch point.

4. The method of claim 1 further comprising, positioning an interface representative of a combination of the download parameters relative to the touch point, wherein the positioning of the interface comprises locating the interface dynamically with respect to the representation and the touch point is automatically set to be indicative of one of default values of the combination of download parameters and most likely target values of the combination of download parameters.

5. The method of claim 1 further comprising, visually indicating the adjustment of the values based on the movement of the touch point via one of an interface representative of a combination of the download parameters positioned relative to the touch point and the representation of the digital media content item.

6. The method of claim 1, wherein an interface representative of a combination of the download parameters positioned relative to the touch point comprises one of a two-dimensional and a three-dimensional visual object, wherein each dimension of the visual object indicates one of each download parameter of the combination of download parameters.

7. The method of claim 1, wherein an interface representative of a combination of the download parameters positioned relative to the touch point comprises a matrix having a plurality of cells, and wherein each cell is indicative of values of each of the download parameters relative to each other.

8. The method of claim 1, wherein an interface representative of a combination of the download parameters positioned relative to the touch point comprises a plurality of hot areas, and wherein each of the plurality of hot areas corresponds to values of each of the download parameters relative to each other.

9. The method of claim 1, wherein the presenting of the values and setting of the presented values is effectuated via a “quick click.”

10. A computer program product, comprising computer code configured to perform the processes of claim 1.

11. An apparatus, comprising:
a processor configured to:
present values of download parameters of a digital media content item relative to a touch point;
adjust the values of the download parameters, if needed, by moving the touch point relative to a representation of the digital media content item; and
transfer the digital media content item based on one of the presented and the adjusted values by releasing the touch point.

12. The apparatus of claim 11, wherein the processor is further configured to position an interface representative of a combination of the download parameters relative to the touch point by locating the interface dynamically with respect to the visual representation and the touch point is set to be indicative of medium values of the combination of download parameters.

13. The apparatus of claim 11, wherein the processor is further configured to position an interface representative of a combination of the download parameters relative to the touch point by locating the interface statically with respect to the visual representation and the touch point is automatically set to be indicative of one of medium values of the combination of download parameters and adjusted values of the combination of download parameters without requiring the movement of the touch point.

14. The apparatus of claim 11, wherein the processor is further configured to position an interface representative of a combination of the download parameters relative to the touch point by locating the interface dynamically with respect to the visual representation and the touch point is automatically set to be indicative of one of default values of the combination of download parameters and most likely target values of the combination of download parameters.

15. The apparatus of claim 11, wherein the processor is further configured to visually indicate the adjustment of the values based on the movement of the touch point via at least one of an interface representative of a combination of the download parameters positioned relative to the touch point and the representation of the digital media content item.

16. The apparatus of claim 11, wherein an interface representative of a combination of the download parameters positioned relative to the touch point comprises one of a two-dimensional and a three-dimensional visual object, wherein each dimension of the visual object indicates one of each download parameter of the combination of download parameters.

17. The apparatus of claim 11, wherein an interface representative of a combination of the download parameters positioned relative to the touch point comprises a matrix having a plurality of cells, and wherein each cell is indicative of values of each of the download parameters relative to each other.

18. The apparatus of claim 11, wherein an interface representative of a combination of the download parameters positioned relative to the touch point comprises a plurality of hot areas, and wherein each of the plurality of hot areas corresponds to values of each of the download parameters relative to each other.

19. The apparatus of claim 11, wherein the presenting of the values and setting of the presented values is effectuated via a “quick click.”
